(19) United States
(12) Patent Application Publication
(10) Pub. No.: US 2002/0197015 A1
(43) Pub. Date: Dec. 26, 2002

(54) Optical chip and an assembly including an optical chip

(75) Inventor: Matthew P. Shaw, Oxford (GB)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Bookham Technology PLC, Abingdon (GB)

(21) Appl. No.: 10/176,388

(22) Filed: Jun. 20, 2002

(30) Foreign Application Priority Data
Jun. 22, 2001 (GB) 0115368.3

(51) Int. Cl. G02B 6/30; G02B 6/42

(52) U.S. Cl. 385/49; 385/88

(57) ABSTRACT

An optical chip (10;110) has a surface (3;103) with an edge (7;107), an optical component (5;105) disposed on the surface spaced from the edge and an optically conductive element (33;133) extending from the optical component to the edge through which the optical component is able to be optically coupled with an optical fiber (25).

### FIELD OF THE INVENTION

The present invention relates firstly to an optical chip having an optical component intended for optical coupling with an optical fibre and secondly to an assembly comprising such an optical chip and an optical fibre. The present invention is particularly, although not exclusively, concerned with integrated optical chips, preferably formed on a silicon substrate.

### BACKGROUND OF THE INVENTION

An optical chip typically comprises a substrate which carries one or more optical components. The optical components may, for example, either produce photocurrent, emit light in response to an injection of electric current, multiplex or demultiplex optical signals of different wavelengths, or simply transport an optical signal. The optical chip may be an integrated optical chip formed by fabricating the optical components on a semiconductor substrate or wafer, typically of silicon. Invariably, a silicon substrate is mounted on an insulator. One example of an optical chip is an optical transceiver in which a laser diode and a photodiode are located on the substrate surface together with associated optical waveguides.

It is known to couple an optical fibre to an optical chip through a mounting block. The optical fibre is secured in an open-ended passageway extending between proximal and distal faces of the mounting block so that the cleaved or free end of the optical fibre is flush with the distal face. The free end and the distal face are polished and the distal face then adhered to a first face of the optical chip. The optical component, meanwhile, is positioned on a second face at an edge shared with the first face. In this way, the free end of the optical fibre is juxtaposed with the optical component so that an optical signal is transferable therebetween, hereinafter referred to as “optical coupling”.

There are three main difficulties in optically coupling an optical fibre with an optical component of an optical chip in this manner.

The first difficulty is polishing the first face of the optical chip to the sufficiently high degree needed to provide an intimate interface with the distal face of the mounting block, and hence the free end of the optical fibre.

The second difficulty arises from the need to reduce the loss of optical signal or insertion loss due to back reflections at the interface between the free end of the optical fibre and the optical component. The typical solution to this is to form the free end of the optical fibre and the first face of the optical chip at complementary inclined angles to the longitudinal axis of the optical fibre. However, it is not easy to polish the first face of the optical chip at an angle complementary to that of the free end of the optical fibre. If the two angles vary, insertion losses result.

The third difficulty is that rounding of the first face can result from the polishing process. Such rounding also leads to insertion losses.

These difficulties arise principally due to the optical component being located at the edge of the chip.

The aim of the present invention is to alleviate these difficulties.

### SUMMARY OF THE INVENTION

According to a first aspect of the present invention there is provided an optical chip having a surface with an edge, an optical component disposed on the surface spaced from the edge and an optically conductive element extending from the optical component to the edge through which the optical component is able to be optically coupled with an optical fibre.

According to a second aspect of the present invention there is provided an assembly comprising an optical chip having an optical component, an optical fibre having a free end coupled to the optical chip so that the free end of the optical fibre is spaced from the optical component, and an optically conductive element extending from the optical component to the free end of the optical fibre to optically couple the optical component to the optical fibre.

According to a third aspect of the invention there is provided an optical chip for use with an optical fibre having a free end, the chip having:

(a) an upper surface,

(b) a side surface,

(c) an edge between the upper and side surfaces,

(d) an optical waveguide for optical coupling with the optical fibre which:

(i) is disposed on the upper surface, and

(ii) has an end face which terminates at a first position on the upper surface which is spaced from a second position on the edge by a distance in the range of substantially 10-30μm, and

(e) an optically conductive element which:

(i) extends from the end face of the optical waveguide to the second position at the edge, and

(ii) is adapted to optically couple the optical waveguide to the optical fibre when the free end of the optical fibre is juxtaposed with the optically conductive element at the second position on the chip edge.

Preferably, the optically conductive element is of a material having a refractive index which is substantially the same as a core of the optical fibre. For example, the variance is preferably below 5%, more preferably below 1% and most preferably below 0.1%.

Preferably, the optical chip has means through which the optical fibre can be aligned with the optically conductive element. As an example, the optical fibre is carried in a carrier with the optical chip and the carrier having alignment features which co-operate so that the optical fibre is juxtaposed to the optically conductive element.

Other preferred features of the present invention are set out in the dependent claims.

By way of example, embodiments of the present invention will now be described with reference to the accompanying Figures of drawings.

### BRIEF DESCRIPTION OF THE DRAWINGS

FIG. 1 is a scrap, plan view of a first optical chip in accordance with the present invention to which an optical fibre is coupled through a carrier;

FIG. 2 is a sectional view along section II-II in FIG. 1;

FIG. 3 is a scrap, exploded perspective view of a second optical chip in accordance with the present invention having alignment grooves, a cover for overlying the optical chip to convert the alignment grooves into sockets, and a carrier carrying an optical fibre having alignment pins for engagement in the sockets to passively align the optical fibre with an optical component on the optical chip;

FIG. 4 is scrap, plan view of the second optical chip coupled with the carrier;

FIG. 5 is a sectional view along section V-V in FIG. 4 with the cover added; and

FIG. 6 is a perspective view of the cover added to the second optical chip.

### DETAILED DESCRIPTION OF THE EXEMPLARY EMBODIMENTS

For ease of reference, like features in the different embodiments hereinafter described with reference to the accompanying FIGURES of drawings are assigned like reference numerals.

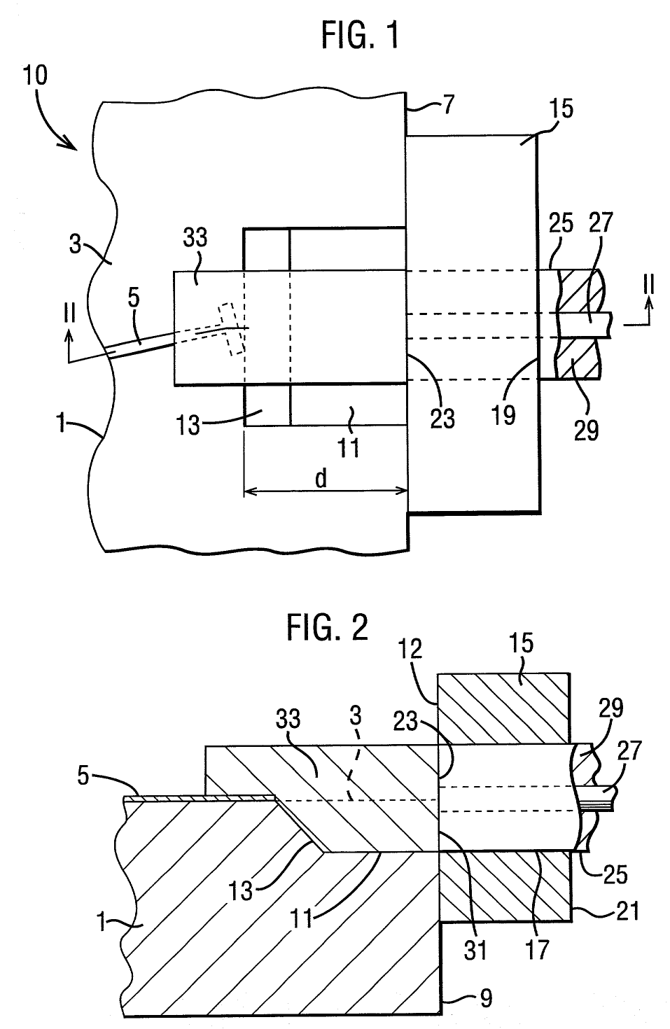

In FIGS. 1 and 2 there is shown an integrated optical chip 10 having a substrate 1, e.g. of silicon, on an upper face 3 of which is formed an optical component 5, in this instance a monolithic optical waveguide 5 such as described in WO95/08787 whose contents are hereby incorporated herein by reference. As can be seen, the waveguide 5 terminates at a position spaced by a distance d from an edge 7 at which the upper face 3 meets a side face 9 of the substrate 1. A groove 11 is chemically etched in the upper face 3 to extend from the edge 7 to the optical waveguide 5. The groove 11 has an end face 13 which inclines away from the edge 7. The purpose of the groove 11 will become clear shortly hereinafter.

The waveguide 5 may be in communication with another optical component on the upper face 3, e.g. a photodiode or a laser diode, or simply extend to an opposed edge (not shown) of the upper face 3.

Mounted to the side face 9 of the substrate 1 is a distal face 12 of a carrier 15. The carrier 15 has a passageway 17 extending from a proximal opening 19 in a proximal face 21 of the carrier 15 to a distal opening 23 in the distal face 12. The distal face 12 of the carrier 15 may be secured to the side face 9 of the substrate 1 through any suitable adhesive, e.g. an epoxy resin, or by soldering.

Secured in the passageway 17 of the carrier 15 is an optical fibre 25, typically of an outer diameter of substantially 125 μm. As is known in the art, the optical fibre 25 has an optically conductive glass core 27 encapsulated within an optical cladding 29 which constrains the path of an optical signal to the core 27 through internal reflection. The optical fibre 25 is secured in the passageway 17 through an adhesive, such as an epoxy resin, so that a free end 31 of the optical fibre 25 is located substantially flush with the distal face 12 of the carrier 15. The co-planar relation between the free end 31 of the optical fibre 25 and the distal face 12 of the carrier 15 is achieved through polishing.

As can be seen, the free end 31 of the optical fibre 25 is spaced from the waveguide by the distance d, which is preferably in the range of 10-30 μm, or substantially 10-30 μm. To optically couple the optical fibre 25 with the waveguide 5, an optically conducting material 33 is mounted in the groove 11 so as to extend from the end of the waveguide 5 to the side face 9 of the substrate 1. Preferably, the optically conducting material 33 has a refractive index which matches that of the glass core 27 of the optical fibre 25. For example, a Spin on Glass (SoG) can be applied in the groove 11 to be interposed between the optical fibre 25 and the waveguide 5. Other possible index-matching materials for the optically conducting material 33 are epoxy resins and encapsulants. An example of a suitable epoxy resin is OPTOCAST 3553 (Electronic Materials, Inc.) and examples of suitable encapsulants are WACKER SilGel® 612 and GE® Silicones RTV615 and RTV655.

Preferably the refractive index of the optically conducting material is greater than 1, i.e. air, and less than 3.5, i.e. silicon. More preferably the refractive index is greater than 1.5 (conventional silica cores) but less than 3.5.

By optically coupling the waveguide 5 to the optical fibre 25 indirectly through the spacing, optically conducting material 33, the difficulties encountered in direct optical coupling outlined hereinabove are ameliorated.

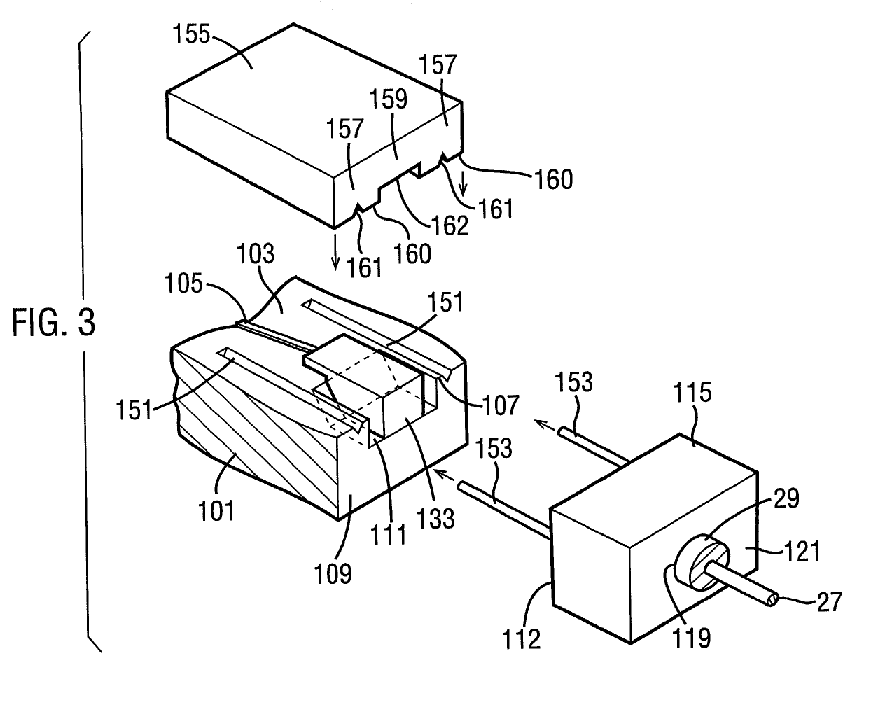

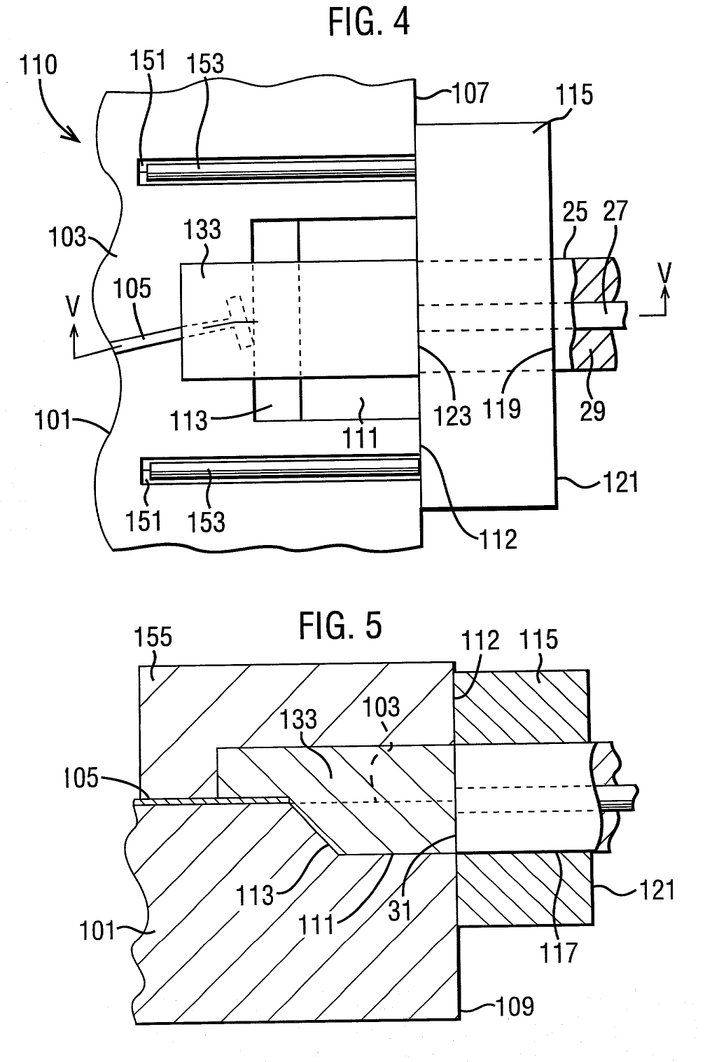

Turning now to FIGS. 3 to 6, there is shown an alternative integrated optical chip 110 of the invention. This optical chip 110 corresponds to the optical chip 10 described with reference to FIGS. 1 and 2 in most respects. However, as shown most clearly in FIGS. 3 and 4, a pair of alignment grooves 151 is etched in the substrate 101 to extend along the upper face 103 from the edge 107. The alignment grooves 151 are disposed on opposing sides of the groove 111 in which the optically conducting material 133 is located. It will be seen from FIGS. 4 and 5 that the distal face 112 of the carrier 115 is provided with a pair of alignment pins 153 for receipt in the alignment grooves 151.

In operation, the alignment pins 153 are fed along the alignment grooves 151 until the distal face 112 of the carrier 115 abuts the side face 109 of the substrate 101. This results in the free end 31 of the optical fibre 25 being positioned so that optical signals can be transferred between the optical fibre 25 and the waveguide 105 through the optically conducting material 133. In other words, the optical fibre 25 is passively aligned with the waveguide 105 through the co-operation of the alignment grooves 151 and the alignment pins 153. The alignment pins 153 may be secured in the alignment grooves 151 through use of a suitable adhesive, such as an epoxy resin.

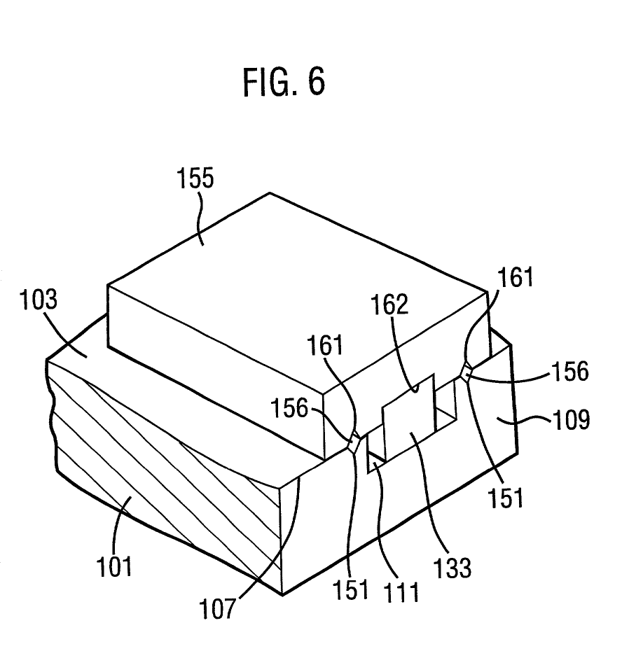

Preferably, a cover 155 made of, for example, silicon is mounted on the upper face 103 of the optical chip 110 to convert the alignment grooves 151 into sockets 156, as shown in FIG. 6. In this way, the alignment pins 153 are held more securely in the alignment grooves 151. Moreover, the carrier 115 can be adhered to the cover 155 in addition to the substrate 101.

As shown in FIGS. 3 and 6, the cover 155 has a pair of leg sections 157 and a bridge section 159 bridging the leg sections 157. An underside 160 of each leg section 157 is provided with a groove 161 which, when the cover 155 is seated to the upper face 103, registers with one of the alignment grooves 151 to form the socket 156. It will, of course, be readily understood that the grooves 161 in the leg sections 157 could be dispensed with provided the alignment pins 153 were sized to fit the resultant socket. As regards the bridge section 159, this has a recessed underside 162 to accommodate the optically conducting material 133. The cover 155 may be secured to the substrate 101 through an adhesive, preferably an epoxy resin, or by soldering.

It will be understood that the present invention is not limited to the exemplary embodiments herein described with reference to, and as shown in, the accompanying FIGURES of drawings. Rather, the invention can be varied in many different ways and adopt other guises within the scope of the appended claims.

1. An optical chip having a surface with an edge, an optical component disposed on the surface spaced from the edge and an optically conductive element extending from the optical component to the edge through which the optical component is able to be optically coupled with an optical fibre.

2. An optical chip according to claim 1, wherein a channel extends from the edge to the optical component and the optically conductive element is in the channel.

3. An optical chip according to claim 1 or 2, wherein the optical component is an optical waveguide.

4. An optical chip for use with an optical fibre having a free end, the chip having:
(a) an upper surface,
(b) a side surface,
(c) an edge between the upper and side surfaces,
(d) an optical waveguide for optical coupling with the optical fibre which:—
(i) is disposed on the upper surface, and
(ii) has an end face which terminates at a first position on the upper surface which is spaced from a second position on the edge by a distance in the range of substantially 10-30 μm, and
(F) an optically conductive element which:
(iii) extends from the end face of the optical waveguide to the second position at the edge, and
(iv) is adapted to optically couple the optical waveguide to the optical fibre when the free end of the optical fibre is juxtaposed with the optically conductive element at the second position on the chip edge.

5. An optical chip according to claim 4, wherein the upper surface has a channel which extends from the second position at the edge to the end face of the optical waveguide and wherein the optically conductive element is in the channel.

6. An optical chip according to claim 1 or 4 further comprising an alignment feature for co-operation with a complementary alignment feature of a carrier carrying the optical fibre so that the optical fibre is juxtaposed to the optically conductive element.

7. An optical chip according to claim 6, wherein the alignment feature is selected from the group consisting of a male feature and a female feature.

8. An optical chip according to claim 6, wherein the alignment feature has a pair of alignment channels extending along the surface from the edge.

9. An optical chip according to claim 8, wherein the alignment channels are located on opposing sides of the optically conductive element.

10. An optical chip according to claim 8, wherein each alignment channel is overlain by a cover to define a pair of sockets.

11. An optical chip according to claim 8, wherein the pair of alignment channels is a first pair of alignment channels and wherein a cover is mounted on the surface, the cover having a second pair of alignment channels registering with the first pair of alignment channels to form a pair of sockets.

12. An optical chip according to claim 10, wherein the optically conductive element forms part of the cover.

13. An optical chip according to claim 1 or claim 4, wherein the optically conductive element is of a material having a refractive index which is substantially the same as a core of the optical fibre.

14. An assembly comprising an optical chip having an optical component, an optical fibre having a free end coupled to the optical chip so that the free end of the optical fibre is spaced from the optical component, and an optically conductive element extending from the optical component to the free end of the optical fibre to optically couple the optical component to the optical fibre.

15. An assembly according to claim 14 in which the optical chip takes the form of an optical chip according to claim 1.

16. An assembly according to claim 15, wherein the surface is a first surface, wherein the edge is between the first surface and a second surface and wherein the optical fibre is coupled to the second surface.

17. An assembly according to claim 16, wherein the optical fibre is carried in a carrier which is coupled to the second surface.

18. An assembly comprising an optical chip according to claim 4 and the optical fibre, the free end of the optical fibre being juxtaposed with the optically conductive element at the second position on the chip edge to optically couple the optical waveguide to the optical fibre.

19. An assembly according to claim 18, wherein the optical fibre is coupled to the side surface.

20. An assembly according to claim 19, wherein the optical fibre is carried in a carrier which is coupled to the side surface.

21. An optical chip according to claim 14 or claim 18, wherein the optically conductive element is of a material having a refractive index which is substantially the same as a core of the optical fibre.

22. An assembly according to claim 17 or claim 20, wherein the carrier is provided with an alignment feature which co-operates with an alignment feature of the optical chip to juxtapose the free end of the optical fibre with the optically conductive element.

23. An assembly according to claim 22, wherein the carrier has a pair of alignment pins mounted in alignment channels of the optical chip.
